(19) United States
(12) Patent Application Publication
(10) Pub. No.: US 2022/0207632 A1
(43) Pub. Date: Jun. 30, 2022

(54) LEGAL PROFESSIONAL SERVICE LOCATION METHOD

(71) Applicant: Michael Jeffrey Leach, Nanaimo (CA)

(72) Inventor: Michael Jeffrey Leach, Nanaimo (CA)

(21) Appl. No.: 17/137,303

(22) Filed: Dec. 29, 2020

(51) Int. Cl. G06Q 50/18; H04L 29/08; G06F 3/0481; G06F 3/0482

(52) U.S. Cl. CPC G06Q 50/18; H04L 67/18; G06Q 30/018; G06F 3/0482; G06F 3/04817

(57) ABSTRACT

A legal advice and referral method wherein the software application of the present invention includes providing legal advice and access to local laws based on the geographical position of the user. The present invention provides a plurality of legal category icons that facilitate the researching of local laws wherein the laws provided are based on the current geographical location of the user. The present invention further includes the ability to facilitate the communicable connection between a user and a legal professional. The legal professionals are assigned a geographical territory upon being registered with the present invention. A user is provided a prompt to be directly connected to a legal professional for an emergency. The present invention further provides the ability for a user to search laws for a location other than their current geographical position.

### FIELD OF THE INVENTION

The present invention relates generally to legal service assistance, more specifically but not by way of limitation, a software application that facilitates the method of the present invention wherein the method of the present invention facilitates providing services such as but not limited to cataloging of various legal statutes, locating a legal professional and legal advice for those having an instant requirement thereof.

### BACKGROUND

Legal services are widely utilized by many individuals and entities for a variety of reasons. These legal services can range from planned needs such as but not limited to business contract and family estate planning to unplanned needs such a but not limited to car accidents or criminal matters. Legal practitioners are available to those individuals requiring assistance with their current legal need. These legal practitioners are specialized in a particular type of law such as but not limited to civil or criminal. As individuals determine a need for a particular type of service there are services such as but not limited to legal referral services. The legal referral services are often provided via phone or internet and they provide a listing of legal practitioners and the type of law that the practice. The legal practitioners listed with these referral services typically pay a fee to be listed as a legal practitioner with the referral service.

One issue with this convention service is the lack of instant availability to a legal practitioner as well as no availability of local or federal laws. In unplanned situations such as but not limited to a car accident or a criminal arrest, an individual may be in both need of the ability to instantly connect with a proper legal practitioner or may need to understand their rights based on the current situation. As law is quite complicated most individuals that find themselves being detained for some alleged offense they do not know or understand what their rights may be at the moment of arrest or detainment. Conventional legal referral services can facilitate a connection with a legal practitioner often hours after the initial need. No existing technology provides an ability to instantly access local laws that may be pertinent to an individual that is being arrested or detained.

It is intended within the scope of the present invention to provide a software application that facilitates a method providing services such as but not limited to locating a legal professional, identifying pertinent local laws applicable to an instant situation and connection with a proper legal practitioner.

### SUMMARY OF THE INVENTION

It is the object of the present invention to provide a software application that facilitates the ability to access local and federal laws so as to provide an understanding of a user's rights for a particular scenario wherein the present invention includes utilization of geographical location in order to ensure relevance for any legal matter for which a user may require.

Another object of the present invention is to provide a legal referral and advice method facilitated by a software application wherein the present invention includes the function to be directly connected with a legal practitioner.

A further object of the present invention is to provide a software application that facilitates the ability to access local and federal laws so as to provide an understanding of a user's rights for a particular scenario wherein the method provides cataloging of local, state and federal laws providing filtering thereof so as to identify the needed statute for a particular scenario in which a user might be included.

Still another object of the present invention is to provide a legal referral and advice method facilitated by a software application wherein the present invention includes the ability to ascertain your rights during an arrest or detainment based on the geographical location of the user.

An additional object of the present invention is to provide a software application that facilitates the ability to access local and federal laws so as to provide an understanding of a user's rights for a particular scenario wherein the legal practitioners available through the software application of the present invention have registered and further been verified.

Yet a further object of the present invention is to provide a legal referral and advice method facilitated by a software application wherein the method includes the step of collecting a fee for speaking with a legal practitioner.

Another object of the present invention is to provide a software application that facilitates the ability to access local and federal laws so as to provide an understanding of a user's rights for a particular scenario that further includes the ability for a legal practitioner to place themselves in an available or unavailable state.

An alternate object of the present invention is to provide a legal referral and advice method facilitated by a software application wherein utilization of the software application of the present invention is free and a fee is collected for calls to a practitioner.

An alternative objective of the present invention is to provide a software application that facilitates the ability to access local and federal laws so as to provide an understanding of a user's rights for a particular scenario wherein the present invention further includes the step of providing security question answers via the phone during use of some of the features of the present invention.

Another object of the present invention is to provide a legal referral and advice method facilitated by a software application wherein every screen of the software application has a icon thereon to facilitate immediate contact of a legal practitioner.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a block diagram of the device configuration of the present invention; and

FIG. 2 is a flowchart of the registration process of the present invention; and

FIG. 3 is a flowchart of the vendor registration process of the present invention; and

FIG. 4 is a flowchart of the utilization process of the present invention.

### DETAILED DESCRIPTION

References now to the drawings submitted herewith, wherein various elements depicted therein are not necessarily drawn to scale and wherein through the views and figures like elements are referenced with identical reference numerals, there is illustrated legal referral and advice method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

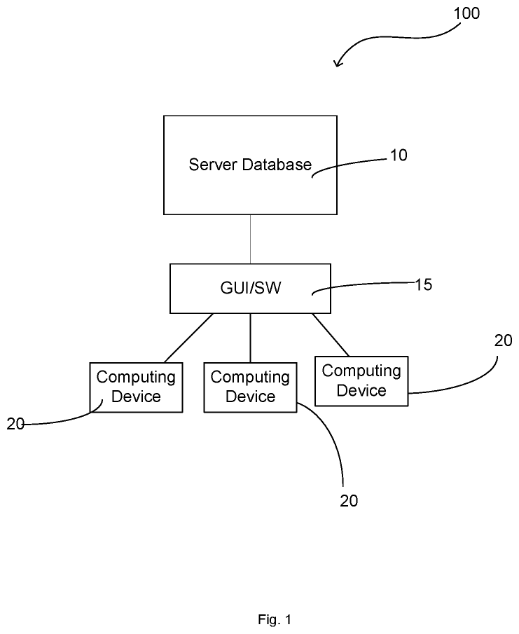

Now referring to the Drawings submitted as a part hereof, the legal referral and advice method 100 is configured to provide instant legal advice and access to legal counsel based on the user's geographical location. As will be further discussed herein the present invention includes the ability to identify the geographic location of the user in order to provide relevant criminal and civil laws. Furthermore, the present invention facilitates the ability for a user to access a legal representative based on the geographic proximity thereto. Referring in particular to FIG. 1, the legal referral and advice method 100 includes a server database 10 that is operably coupled to the Internet utilizing conventional communication protocols. The server database includes the necessary electronics to receive, store, transmit and manipulate data. It should be understood within the scope of the present invention that more than one server database 10 could be employed in operation of the legal referral and advice method 100. The graphical interface software 15 is a software application that provides the necessary graphical interface in order to facilitate utilization of the legal referral and advice method 100. The graphical interface software 15 in a preferred embodiment is a software application configured to be operated on a smart phone. A plurality of computing devices 20 have the graphical interface software 15 stored thereon wherein the computing devices 20 are smart phones or similar portable computing devices.

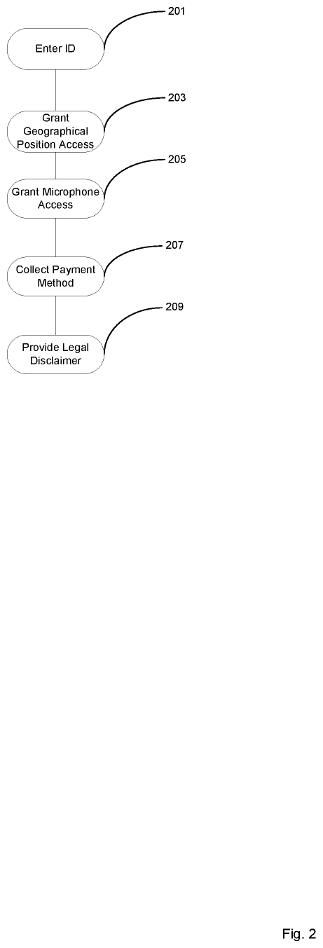

Now referring in particular to FIG. 2 submitted herewith, an overview of the registration process is outlined therein. Ensuing downloading the graphical software interface 15 onto a computing device 20 a user will be required to register with the legal referral and advice method 100 and as such the operator thereof. In step 201, the user will be prompted for identification information such as but not limited to name, date of birth, residence address and contact information such as but not limited to email. Step 203, the user will be prompted to allow access to their geographical position to which the user will need to accept. In step 205, the user will be additionally prompted to provide access to the microphone of the portable computing device 20 on which the present invention is loaded. It should be understood within the scope of the present invention that microphone access and geographic location identity are granted during utilization of the legal referral and advice method 100 only. Step 207, the user will enter a payment method such as but not limited to credit card information. While a payment method is entered it should be understood within the scope of the present invention that the legal referral and advice method 100 is substantially provided at no cost to a user and only select services are fee based. In step 209, the user will be provided and must accept the legal disclaimer of the legal referral and advice method 100 wherein a disclaiming of accuracy due to government entity changes and the timing thereof may have impact of the legal advice provided.

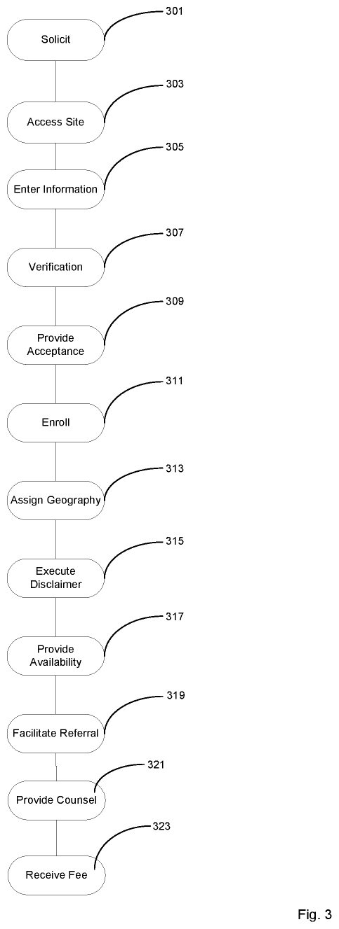

FIG. 3 provides an overview of the vendor registration process of the present invention. In step 301 the operator of the legal referral and advice method 100 will solicit for legal professionals such as attorneys in desired geographical areas. Step 303, the legal professionals will access a website provided to facilitate their registration with the legal referral and advice method 100 to be so as to become an enrolled legal provider for users of the legal referral and advice method 100. In step 305, potential legal providers will enter their professional information to include but not be limited to all professional certifications. Step 307, the operator of the legal referral and advice method 100 will subsequently verify all of the professional credentials of an applying legal professional to ensure the validity thereof. In step 309, ensuing verification of the validity of the professional credentials the operator of the legal referral and advice method 100 will provide acceptance to the applying legal professional.

Step 311, the legal professional will be officially enrolled as a provider for the legal referral and advice method 100. In step 313, the legal professional will be assigned a geography for which they will be providing legal services to clients of the legal referral and advice method 100. The geography can be where the legal provider has a place of business or be licensed to practice law. Step 315, the legal professional will be required to sign a disclaimer/oath ensuring commitment to provide sound legal advice to clients of the legal referral and advice method 100. In step 317, once active the legal professional will provide their availability to the operator of the legal referral and advice method 100 so as to be available for clients needing counsel. Availability can be set up as a scheduled set of days and or times or could be at all times. In step 319, the legal referral and advice method 100 will facilitate a referral to a legal professional registered therewith. Step 321, the legal professional will provide counsel and/or legal advice to the referred client. The counsel and/or legal advice can be for an instant need and/or be facilitated in person at the place of business of the legal professional. In step 323, the legal professional will receive a fee from the operator of the legal referral and advice method 100 for providing instant counsel and/or legal advice to a user of the legal referral and advice method 100.

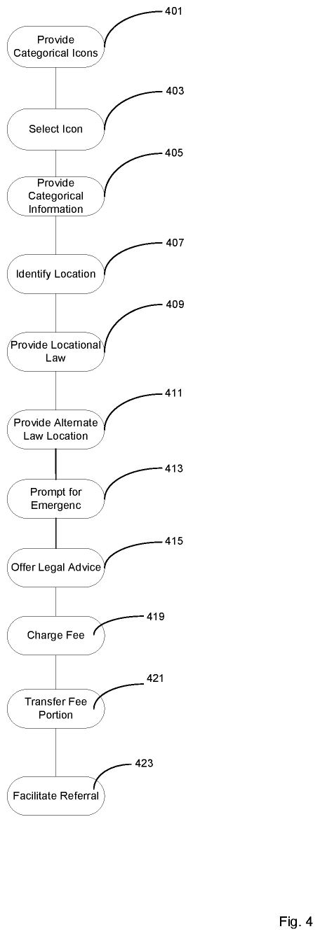

Referring to FIG. 4 submitted herewith, an outline of the utilization process of the legal referral and advice method 100 is illustrated therein. In step 401 the software interface of the legal referral and advice method 100 provides a plurality of category icons. The category icons are provided in order for a user to identify and determine the desired category to further explore. The category icons are legal based and include but are not limited to legal categories such as basic rights, laws, bylaws, federal laws, state laws and motor vehicle laws. A user is able to visually identify the correct legal category and then select the appropriate icon so as to subsequent drill down into the category and discover the desired information. In step 403, a user will select a desired icon. Step 405, ensuing selection of the desired icon, the legal referral and advice method 100 will facilitate the providing of the legal information in that category wherein it should be understood within the scope of the present invention that further data mining is provided. In step 407, the present invention will further identify the present geographic location of the user. Step 409, based on the present geographical location of the user exploring the category icons, the legal referral and advice method 100 will provide relevant location based law thereto. In step 411, the user will be prompted to select alternate locational related law wherein the user can select an alternate entity such as but not limited to city, state or country and upon selection will be provided with the relevant laws thereto.

In step 413, the user will be prompted if the legal counsel need is an emergency. It is contemplated within the scope of the present invention that every page of the graphical interface of the software of the present invention has provided thereon an access icon(s) to be connected immediately to legal counsel. Step 415, the legal referral and advice method 100 will provide the selected legal advice from the catalog of laws stored therein. Alternately, the legal advice will be provided by a legal counsel with which the user was connected. In step 419, the operator of the legal referral and advice method 100 will charge a user a fee wherein a fee is charged if a direct connection to a legal counsel was selected. Step 421, a portion of the fee collected from the user for facilitating the direct connection to legal counsel is transferred to the selected legal counsel. Step 423, the legal referral and advice method 100 will further facilitate referral to an alternate legal professional based on additional needs from the user. It should be additionally understood within the scope of the present invention that the legal referral and advice method 100 will provide a contact phone number and have security protocols associated therewith so as to permit users of the legal referral and advice method 100 to call the operator of the legal referral and advice method 100 in the event access to their remote computing device is restricted.

While a preferred embodiment of the present invention has been described and illustrated herein, it is contemplated within the scope of the present invention that additions and/or alterations could be included. By way of example but not limitation, it is contemplated within the scope of the present invention that the legal referral and advice method 100 could include content pushes wherein the content pushes could occur at any interval during utilization of the legal referral and advice method 100. Content pushes are defined herein as legal information pertaining to various rights or laws that the general public is unaware. Additionally, these content pushes could include verdicts and/or outcomes of legal cases wherein the outcome was a result of leveraging a particular obscure statute of local law.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A legal referral and advice method operable to provide legal advice for registered users thereof that comprises the steps of:
providing a server database, said server database having necessary electronics to receive, store, transmit and manipulate data, said server database being communicably coupled to Internet utilizing suitable communication protocols;
offering a software application, wherein the software application is stored on the server database and operable to be downloaded onto a remote computing device;
registering a plurality of legal professionals, wherein a plurality of legal professionals are registered with the legal referral and advice method;
registering a plurality of users, wherein registration of the plurality of user includes recording of demographic and contact information;
granting geographical position access, wherein the plurality of users will permit attainment of a geographical position thereof during use of the legal referral and advice method;
providing a plurality of legal category icons, wherein a user is provided via a graphical user interface software application a plurality of legal icons;
selecting a legal category icon, wherein the user will select one of the plurality of legal category icons;
providing legal statutes to the user, wherein the legal statutes provided to the user are relevant to the geographical position of the user; and
offering an option to be connected with a legal counsel.

2. The legal referral and advice method as recited in claim 1, and further including the step of verifying legal credentials of the legal professionals.

3. The legal referral and advice method as recited in claim 2, and further including the step of permitting access to a microphone on a remote computing device of a user during use of the legal referral and advice method.

4. The legal referral and advice method as recited in claim 3, and further including the step of prompting the user for emergency connection with one of the plurality of legal professionals.

5. The legal referral and advice method as recited in claim 4, and further including the step of offering an alternate geographical location for which to identify and determine local laws thereof.

6. The legal referral and advice method as recited in claim 5, and further including the step of collecting a fee, wherein a user will pay a fee for direct connection to one of said plurality of legal professionals.

7. The legal referral and advice method as recited in claim 6, and further including the step of providing availability, wherein the plurality of legal professionals will provide available dates and times to be accessible for offering of legal counsel.

8. The legal referral and advice method as recited in claim 7, and further including the step of executing a disclaimer, wherein the disclaimer releases legal liability of the operator of the legal referral and advice method.

9. The legal referral and advice method as recited in claim 8, and further including the step of assigning a geography to the plurality of legal professionals, wherein the plurality of legal professionals are assigned a geography for which to provide users legal counsel.

10. A legal referral and advice method operable to provide legal advice and direct contact to legal counsel based on a geographical position of registered users thereof that comprises the steps of:
providing a server database, said server database having necessary electronics to receive, store, transmit and manipulate data, said server database being communicably coupled to Internet utilizing suitable communication protocols;
offering a software application, wherein the software application is stored on the server database and operable to be downloaded onto a remote computing device;
registering a plurality of legal professionals, wherein a plurality of legal professionals are registered with the legal referral and advice method;
verifying professional credentials of the plurality of the legal professionals, wherein and operator of the legal referral and advice method will verify the professional credentials of legal counsel during registering thereof;
registering a plurality of users, wherein registration of the plurality of user includes recording of demographic and contact information;
granting geographical position access, wherein the plurality of users will permit attainment of a geographical position thereof during use of the legal referral and advice method;
tracking the geographical position of the plurality of uses, wherein the software application tracks the geographical position of the plurality of users during use of the software application;
providing a plurality of legal category icons, wherein a user is provided via a graphical user interface software application a plurality of legal icons, wherein the category legal icons are separated by types of law;
selecting a legal category icon, wherein the user will select one of the plurality of legal category icons;
providing legal statutes to the user, wherein the legal statutes provided to the user are relevant to the geographical position of the user;
offering to provide legal information for a second geographical location, wherein the user can select to see laws for a location other than the present geographical location of the user; and
offering an option to be connected with a legal counsel.

11. The legal referral and advice method as recited in claim 10, and further including the step of providing availability, wherein the plurality of legal professionals will provide available dates and times to be accessible for offering of legal counsel.

12. The legal referral and advice method as recited in claim 11, and further including the step of prompting the user for emergency connection with one of the plurality of legal professionals.
